(19) United States
(12) Patent Application Publication
(10) Pub. No.: US 2019/0372426 A1
(43) Pub. Date: Dec. 5, 2019

(54) CROSS-OVER ELECTRO-MAGNETIC ENGINE

(71) Applicant: ANCON DEVELOPMENT CORPORATION, Escondido, CA (US)

(72) Inventor: Terry Van Gelder, Escondido, CA (US)

(73) Assignee: ANCON DEVELOPMENT CORPORATION, Escondido, CA (US)

(21) Appl. No.: 16/428,988

(22) Filed: Jun. 1, 2019

Related U.S. Application Data
(60) Provisional application No. 62/679,754, filed on Jun. 1, 2018.

(51) Int. Cl. H02K 7/02; B60L 7/26; B60T 1/06; F16D 55/40; B60K 7/00; F16D 65/18; F02P 1/00; H02K 7/116; H02K 7/102

(52) U.S. Cl. CPC H02K 7/02; B60L 7/26; B60T 1/065; F16D 55/40; B60L 7/10; F16D 65/186; F02P 1/00; H02K 7/116; H02K 7/102; B60K 7/0007

(57) ABSTRACT

The present invention is directed to a Cross-over Electro-Magnetic Engine system and method for making a Cross-over Electro-Magnetic Engine. More particularly, two types of Cross-over Electro-Magnetic Engine systems are disclosed having two types of electromagnetic generator mechanisms, a wheel drive power control box, a storage battery and/or capacitor, wheel gear drives connected to magnetic motors, an ignition module and an electric braking system with back-up mechanical brakes. Power from the cross-over electro-magnetic engine is transferred to the generator systems having rotating plates or counter-rotating plates, then transferred to the wheel drive power control box where it is sent to the magnetic motors to drive wheel gear drives for each wheel driven.

### FIELD OF THE INVENTION

The present invention is directed to a Cross-over Electro-Magnetic Engine system and method for making a Cross-over Electro-Magnetic Engine. More particularly, two types of Cross-over Electro-Magnetic Engine systems are disclosed having two types of electromagnetic generator mechanisms, a wheel drive power control box, a storage battery and/or capacitor, wheel gear drives connected to magnetic motors, an ignition module and an electric braking system with back-up mechanical brakes. Power from the cross-over electro-magnetic engine is transferred to the generator systems having rotating plates or counter-rotating plates, then transferred to the wheel drive power control box where it is sent to the magnetic motors to drive wheel gear drives for each wheel driven.

### BACKGROUND OF THE INVENTION

A hybrid electric vehicle (HEV) is a type of hybrid vehicle that combines a conventional internal combustion engine (ICE) system with an electric propulsion system (hybrid vehicle drivetrain). The presence of the electric powertrain is intended to achieve either better fuel economy than a conventional vehicle or better performance. There is a variety of HEV types, and the degree to which each functions as an electric vehicle (EV) also varies. The most common form of HEV is the hybrid electric car, although hybrid electric trucks (pickups and tractors) and buses also exist.

Modern HEVs make use of efficiency-improving technologies such as regenerative brakes which convert the vehicle's kinetic energy to electric energy to charge the battery. Some varieties of HEV use their internal combustion engine to generate electricity by spinning an electrical generator to either recharge their batteries or to directly power the electric drive motors; this combination is known as a motor-generator. Many HEVs reduce idle emissions by shutting down the ICE at idle and restarting it when needed; this is known as a start-stop system. A hybrid-electric produces less emissions from its ICE than a comparably sized gasoline car, since an HEV's gasoline engine is usually smaller than a comparably sized, pure gasoline-burning, vehicle and if not used to directly drive the car, can be geared to run at maximum efficiency, further improving fuel economy. (Natural gas and propane fuels produce fewer emissions.)

Although Ferdinand Porsche developed the Lohner-Porsche in 1901, hybrid electric vehicles did not become widely available until the release of the Toyota Prius in Japan in 1997, followed by the Honda Insight in 1999. While initially, perceived as unnecessary due to the low cost of gasoline, worldwide increases in the price of petroleum caused many automakers to release hybrids in the late 2000s; they are now perceived as a core segment of the automotive market of the future.

As of January 2017, over 12 million hybrid electric vehicles have been sold worldwide since their inception in 1997. As of April 2016, Japan ranked as the market leader with more than 5 million hybrids sold, followed by the United States with cumulative sales of over 4 million units since 1999, and Europe with about 1.5 million hybrids delivered since 2000. Japan also has the world's highest hybrid market penetration. In 2016 the hybrid market share accounted for 38% of new standard passenger car sales, and 25.7% of new passenger vehicle sales including kei cars. Norway ranks second with a hybrid market share of 6.9% of new car sales in 2014, followed by the Netherlands with 3.7%, France and Sweden, both with 2.3%.

Global sales are led by the Toyota Motor Company with more than 10 million Lexus and Toyota hybrids sold as of January 2017,^{[5]} followed by Honda Motor Co., Ltd. with cumulative global sales of more than 1.35 million hybrids as of June 2014; Ford Motor Corporation with over 424,000 hybrids sold in the United States through June 2015; and the Hyundai Group with cumulative global sales of 200,000 hybrids as of March 2014, including both Hyundai Motor Company and Kia Motors hybrid models. As of January 2017, worldwide hybrid sales are led by the Toyota Prius liftback, with cumulative sales of almost 4 million units. The Prius nameplate had sold more than 6 million hybrids up to January 2017. Global Lexus hybrid sales achieved the 1 million unit milestone in March 2016. As of January 2017, the conventional Prius is the all-time best-selling hybrid car in both Japan and the U.S., with sales of over 1.8 million in Japan and 1.75 million in the United States.

Hybrid electric vehicles can be classified according to the way in which power is supplied to the drivetrain:
In parallel hybrids, the ICE and the electric motor are both connected to the mechanical transmission and can simultaneously transmit power to drive the wheels, usually through a conventional transmission. Honda's Integrated Motor Assist (IMA) system as found in the Insight, Civic, Accord, as well as the GM Belted Alternator/Starter (BAS Hybrid) system found in the Chevrolet Malibu hybrids are examples of production parallel hybrids. The internal combustion engine of many parallel hybrids can also act as a generator for supplemental recharging. As of 2013, commercialized parallel hybrids use a full size combustion engine with a single, small (<20 kW) electric motor and small battery pack as the electric motor is designed to supplement the main engine, not to be the sole source of motive power from launch. But after 2015 parallel hybrids with over 50 kW are available, enabling electric driving at moderate acceleration. Parallel hybrids are more efficient than comparable non-hybrid vehicles especially during urban stop-and-go conditions where the electric motor is permitted to contribute, and during highway operation.
In series hybrids, only the electric motor drives the drivetrain, and a smaller ICE (also called range extender) works as a generator to power the electric motor or to recharge the batteries. They also usually have a larger battery pack than parallel hybrids, making them more expensive. Once the batteries are low, the small combustion engine can generate power at its optimum settings at all times, making them more efficient in extensive city driving.
Power-split hybrids have the benefits of a combination of series and parallel characteristics. As a result, they are more efficient overall, because series hybrids tend to be more efficient at lower speeds and parallel tend to be more efficient at high speeds; however, the cost of power-split hybrid is higher than a pure parallel. Examples of power-split (referred to by some as “series-parallel”) hybrid powertrains include 2007 models of Ford, General Motors, Lexus, Nissan, and Toyota.
   In each of the hybrids above is common to use regenerative braking to recharge the batteries.

Regenerative braking is an energy recovery mechanism which slows a vehicle or object by converting its kinetic energy into a form which can be either used immediately or stored until needed. In a nutshell, the electric motor is using the vehicle's momentum to recover energy that would be otherwise lost to the brake discs as heat. This contrasts with conventional braking systems, where the excess kinetic energy is converted to unwanted and wasted heat by friction in the brakes, or with dynamic brakes, where energy is recovered by using electric motors as generators but is immediately dissipated as heat in resistors. In addition to improving the overall efficiency of the vehicle, regeneration can greatly extend the life of the braking system as its parts do not wear as quickly.

U.S. Pat. No. 6,441,506 of Nakashima provides for a parallel hybrid vehicle employing a parallel hybrid system, using both an internal combustion engine and an electric motor generator for propulsion, a desired motor/generator torque is map-retrieved based on both the engine speed and throttle opening from a predetermined characteristic map in a fashion of feedforward processing. The signal indicative of the desired motor/generator torque is subjected to a low-pass filter that passes signals included in a frequency band lower than an oscillation frequency of powertrain torsional vibrations to remove the powertrain vibration frequency components. The map is preprogrammed so that the desired motor/generator torque is set at zero in a specified speed range lower than an engine idle speed. In another specified speed range from the engine idle speed to a predetermined direct-coupling engine speed that permits the motor/generator to be directly coupled with the engine, a gain of the desired motor/generator torque is set to increase with an increase in the engine speed. In a specified speed range above the predetermined direct-coupling engine speed, the motor/generator is coupled directly with the engine, so that the motor/generator torque output produced from the motor/generator is substantially identical to the engine torque output.

While Nakashima teaches and discloses a parallel hybrid vehicle having both an internal combustion engine and an electric motor generator for propulsion, it does not provide a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

US Patent Application Publication No. 2008/0197721 A1 of Reyes is directed to a method for modifying a current gas or diesel engine, or building a new one, which utilizes a magnetic field produced by solenoids in the cylinders or cylinder cover to exert force on a modified piston to turn a crankshaft. The present invention removes the need for fuel and eliminates emissions. The present invention utilizes the alternator in normal operation to provide the current through the solenoids to produce magnetic fields. Vehicle speed is controlled by changing the amount of current going through the solenoid. This process changes the magnitude of the originating and induced magnetic fields of the solenoid and piston. The operation of the vehicle remains similar to traditional operation, except the greatly beneficial aspects of not needing fuel or producing emissions.

Whereas Reyes provides a method for modifying a current gas or diesel engine utilizing a magnetic field produced by solenoids in the cylinders or cylinder cover to exert force on a modified piston to turn a crankshaft, it does not teach or disclose a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

US Patent Application Publication No. 2012/0007447 A1 of Gosvenor provides a magnetically actuated reciprocating motor utilizes the stored energy of magnets, particularly rare earth magnets, and an electromagnetic field to reciprocally drive a magnetic actuator. A converting mechanism, such as a connecting rod and crankshaft, converts the reciprocating motion of the magnetic actuator to rotary motion for powering a work object. A solenoid, comprising a nonferromagnetic spool having a tubular center section with a coil of wire wrapped around the center section, is connected to a source of power and a switching mechanism. The switching mechanism switches the magnetic polarity at the ends of the solenoid to alternatively repel and attract permanent magnets at the ends of the magnetic actuator. A shaft interconnecting the magnets is received through the center section of the solenoid. A controlling mechanism interconnecting an output shaft and the switching mechanism provides the timing to switch the polarity of the solenoid to drive the magnetic actuator.

Gosvenor provides a magnetically actuated reciprocating motor which utilizes magnets and an electromagnetic field to drive a magnetic actuator, it does not disclose a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

US Patent Application Publication No. 2011/0193503 A1 of Miles et al. provides a magnetically controlled reciprocating engine having a unique electromagnet control system. The engine is constructed and arranged to operate from a stored power source such as batteries to provide extended run times by controlling the power supplied to the electromagnets in a manner that controls heat generation within the electromagnetic coils, thereby increasing coil life. The control system is also capable of controlling engine speed and/or torque outputs to make the engine versatile for a wide variety of uses. The system is constructed and arranged to be utilized on new or pre-existing engines of various configurations and may be utilized in other industries or devices that benefit from the use of electromagnets.

Miles et al. teaches a magnetically powered reciprocating engine and electromagnetic control system using a stored power source such as batteries. It does not disclose a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

U.S. Pat. No. 4,631,455 of Taishoff is directed to an electric starter motor and generator is integrated into the structure of an internal combustion engine by making the ferromagnetic pistons of the engine the relatively moving elements in the starter and generator. A coil is solenoidally wound around each sleeve of the engine. An electronically controlled switch sends battery current into an appropriate coil inducing a powerful magnetic field therearound. The magnetic field and piston interact resulting in a powerful magnetic force which moves the piston and thus cranks the engine. At appropriate times in the operation of the engine, fuel to the same can be shut off and the engine run as a high speed electric motor.

The Taishoff patent is directed to a method and apparatus for converting a conventional internal combustion engine into a high speed electric motor and generator, by the integration of ferromagnetic pistons and a coil wound around each sleeve of the engine. It does not teach or disclose a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

U.S. Pat. No. 6,049,146 of Takara relates to an electromagnetic piston engine capable of producing driving power by a reciprocal movement of a piston in a cylinder by electromagnetic force. The present invention has the objects to provide the electromagnetic piston engine which can do without a variety of resistance inherent in internal combustion piston engines, which reduces the weight corresponding to a rotary assembly portion to a smaller value even if a great output is produced, which can be readily employed together with power transmission mechanisms and so on for use with conventional internal combustion piston engines, and which has a high efficiency in energy consumption. The electromagnetic piston engine is provided with the cylinder and the piston made each of a magnetic material as well as with as the cylinder electromagnet having the inner wall of the cylinder magnetizable to a one magnetic pole and with the piston magnetization unit for magnetizing a portion of the piston engageable with the cylinder to a single magnetic pole in a fixed manner. The magnetization of the cylinder electromagnet generates magnetically attracting force between the cylinder and the piston to cause the piston to move in a one direction and thereafter magnetically repellent force to transfer the piston in the opposite direction. This series of the actions are repeated to provide a continual reciprocal movement of the piston.

The Takara patent provides an electromagnetic piston engine driving power by the electromagnetic forces on a piston in a cylinder thereby reducing the weight and increasing efficiency of energy consumption. Takara does not disclose a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

US Patent Application Publication No. 2003/0102753 A1 of Sprain describes that energy is generated by an apparatus and process which utilize magnetic forces to move a rotor in a circular direction to turn a rotor shaft. This apparatus and process convert magnetic energy into mechanical force or electrical energy.

The Sprain reference is directed to an apparatus and process for generating energy using magnetic forces to move a rotor in a circular direction and turning a rotor shaft thereby converting magnetic energy into mechanical or electrical energy. Sprain does not disclose or teach a Cross-Over Electro-Magnetic Engine system and method wherein power from the cross-over electro-magnetic engine is transferred to the generator systems having rotating plates or counter-rotating plates, then transferred to the wheel drive power control box where it is sent to the magnetic motors to drive wheel gear drives for each wheel driven.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed. herein are for the purpose of description and should not be regarded as limiting.

### SUMMARY OF THE INVENTION

The principle advantage of this invention is that it provides an Electro-Magnetic Engine designed to operate using electromagnetic forces to power engine movement and utilizes fossil fuels in conjunction with electromagnetic forces to force engine movement.

Another advantage of this invention is that it provides a Cross-over Electro-Magnetic Engine which can use traditional pistons, rotary type internal propulsion methods such as a Wankel rotary engine or aircraft turbine or jet propulsion to produce power through use of electromagnetic forces applied to the internal spinning circular discs.

Another advantage of this invention is that it provides a Cross-over Electro-Magnetic Engine including a piston operated electromagnetic engine, magnetic forces both push the piston down and reverse magnetism retracts or pulls the piston upwards.

Another object of this invention is that it provides a Cross-over Electro-Magnetic Engine having a piston operated electromagnetic engines, transferring of combustion forces (exhaust gases) can be transferred to a turbo motor which can assist the crankshaft rotation or can be used to power onboard generators, air conditioning units, etc.

Another object of this invention is that it provides a Cross-over Electro-Magnetic Engine which powers a generator which shall employ the use of circular counter rotating disc plate armatures.

Another object of this invention is that it provides a Cross-over Electro-Magnetic Engine enabling power transfer from the electromagnetic engine to the generator by common driveshaft to a right angle gear box which powers the vertical shaft within the generator.

And yet another object of this invention is that it provides a Cross-over Electro-Magnetic Engine having wheel gear drives shall employ an electric reverse power system for braking.

Another advantage of this invention is that it provides a Cross-over Electro-Magnetic Engine where the electric energy produced by the counter rotating disc plate generator shall be transferred to electric motor wheel gear drives, the electro-magnetic operation of the cross over engine and back into the generator for assisted power rotation being produced by every other disc plate armature.

Another advantage of this invention is that it provides a Cross-over Electro-Magnetic Engine in which the entire vehicle drive system shall be controlled by an electronic control box to vary speed and voltage to the vehicle electric wheel drive units.

The present invention comprises in a piston operated cross-over electromagnetic engine, magnetic forces both push the piston down and reverse magnetism retracts or pulls the piston upwards. In addition, the crankshaft rotation shall also be assisted by electromagnetic forces. To accomplish the crankshaft electromagnetic assisted rotation, this engine shall have several clover leaf flywheels located along the length of the crankshaft. These clover leaf flywheels have independent lobes and at the outer surface of these lobes, have a segmented magnetic field located on the outer edge of each lobe. Surrounding each cloverleaf flywheel are electromagnetic fields which are energized in sequence to pull and push the cloverleaf flywheels in a circular motion with magnetic forces.

Moreover, in the piston operated cross-over electromagnetic engines, transferring of combustion forces (exhaust gases) can be transferred to a turbo motor which can assist the crankshaft rotation or can be used to power onboard generators, air conditioning units, etc. The exhaust turbo motors will employ the use of planetary gear reduction to maximize output shaft power and torque. In addition, exploded fuel creates a fiery exhaust, this fiery exhaust can be piped into another piston approaching the combustion position. The fiery injection into an opposing piston ready to fire will aid in a more efficient burn of the atomized fuel. The use of intake or exhaust valves are not required in the design of the piston engine but can be used. The intake and exhaust cycles of the piston engine are accomplished by cylinder porting. Engine intake air is forced into the cylinder chamber and exhaust gases are forced out of the cylinder chamber by a supercharger located on or attached to the engine when the engine piston is at the bottom of the piston stroke

Circular counter rotating disc plate armatures within the generator operate on a common shaft. On the common shaft, the first disc plate armature will spin in clockwise rotation, the next disc plate armature in the series will spin in counter clockwise rotation by use of planetary gears or similar means. Then the next disc plate armature in the series will spin again in clockwise rotation, the next disc plate armature in counter clockwise rotation with this alternating rotation effect continued throughout the generator. There is no limit on the disc plate armatures in any given generator, but the principle and set up is the same, every other disc plate armature spins in the opposite direction from the next disc plate armature in the series. Cross-over electromagnetic engines shall power the generator which shall employ the use of circular counter rotating disc plate armatures. The use of counter rotating circular disc armatures within the generator will create a gyro affect at high speed rotation which will stabilize a vehicle and provide resistance from rollover accidents. Counter rotating circular disc generators are not limited to vehicle use. They will and can be used in any commercial or household power generation requirement. These counter rotating electromagnetic generators can be converted over to electric motor use by providing an outside electrical power source.

All electric producing generators or motors shall employ a circular weighted disc plate armature for internal power generation. These electromagnetic disc plates' armatures will be arranged in a back to back series on a common shaft. Each one of these circular disc plates' armatures shall be weighted at the exterior perimeter for centrifugal force energy. Additionally, they will also have electromagnetic lobes attached at the exterior circumference to interact with the circular case containing the electromagnetic fields which will use magnetism to produce electricity by the interaction of the spinning electromagnetic plates. It is also possible that every other disc plate armature on the common shaft can be used to power the generator without using an auxiliary input rotational power source such as the cross over electro-magnetic engine. So, in the counter-rotating generator series of disc plate armatures, one disc plate armature is spinning clockwise and will be producing electrical current. The next disc plate armature in the series on the common shaft and utilizing a planetary gear or similar means will be spinning in counter clockwise rotation. This disc plate armature will be consuming some the power produced by the clockwise rotating disc plate armature to power rotation of the generator, operating as an electric motor not a generator disc plate armature. So, in summary, in the multiple series of disc plate armatures within the generator, clockwise rotating disc plate armatures shall produce electrical current and the next disc plate armature in the series will use produced electrical current to power the generator as in an electric motor. One disc plate armature produces power and the next disc plate armature uses some of the power to continue rotation of the generator. These generators can be used as electric motors by introducing an outside electrical source. Traditional electric motor coil fields can be used.

Power transfer from the cross-over electromagnetic engine to the generator by common driveshaft to a right angle gear box which powers the vertical shaft within the generator. The counter rotating generator should be mounted horizontally behind the engine in-between the frame rails of the vehicle. However, it can also be mounted upright where the shaft is horizontally, and the generator connects directly to the backside of the engine. If this method is used, the generator diameter will be limited by available space in the engine bay and firewall area.

Wheel gear drives shall employ an electric reverse power system for braking. Reverse polarity in the electromagnetic drive motor will create a reverse rotation force in the motor which will act as a braking force. In addition, a backup mechanical brake system shall be incorporated in the electric motor gear drive. The backup mechanical brakes shall be a combination of full circle brake discs with braking compounds attached to both faces and opposing flywheels. The full circle braking discs with braking compounds will be compressed against the opposing flywheels by hydraulic means and upon contact will arrest movement of the gear drive unit. These braking systems can be dry or liquid bath. Current pad and rotor systems or drum type braking systems can be converted over to the full circular disc and flywheel system on all current production vehicles and any machinery device requiring rotation speed braking.

Furthermore, the entire vehicle drive system shall be controlled by an electronic control box to vary speed and voltage to the vehicle electric wheel drive units. When the electric wheel gear drive and full circular braking disc and flywheel braking systems are used in a vehicle, during a left hand turn the, the left side electric gear drive motors are depowered, and the right side electric wheel gear drive motors receive additional power to assist the vehicle's left hand turns. This is especially helpful in off road dirt racing. When the electric wheel gear drive and full circular braking disc and flywheel braking systems are used in a vehicle, during a right hand turn, right side electric gear drive motors are depowered, and the left side electric gear drive motors receive additional power to assist the vehicle's right hand turns.

It must be clearly understood at this time although the preferred embodiment of the invention consists of the Electro-Magnetic Engine, that many conventional mechanical actuating devices exist, including electric motors, gas and other fossil fuel powered motors, hydraulic driven motors and pneumatic driven motors, or combinations thereof, that will achieve a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a schematic diagram of the Electro-Magnetic Engine driving an electromagnetic generator with vertical counter rotating disc plate armatures located and connected directly behind the cross-over engine, or an electromagnetic generator having horizontal counter rotating disc plate armatures located away from the cross-over engine in between the frame rails of the vehicle and powered by a drive shaft from the cross-over engine to the generator. It further illustrates electric power produced by the counter rotating disc armature generator being distributed to the independent electric wheel drive assemblies.

FIG. 2 depicts a cross-section through an engine having two pistons driving each magnetic cloverleaf flywheel. Cross-over engine is not limited to two pistons and can be in arranged in multiple two piston series. Also, the two pistons can also be connected to a common shaft on the cloverleaf flywheels.

FIG. 3 depicts a cross-section through an engine having two pistons each driving one magnetic cloverleaf flywheel. It also illustrates the use of two crankshafts in one cross-over engine to produce more power than a traditional single crankshaft cross-over engine. This concept can be used in current production combustion engines. Cross-over engine is not limited to two pistons but can be arranged in multiple two piston series with a dual crankshaft configuration.

FIG. 4 depicts a cross-section through an engine having one piston driving one magnetic cloverleaf flywheel. Cross over engine is not limited to one piston but can be in multiple one piston series.

FIG. 5 depicts a front perspective exploded view of the engine shown in FIG. 2;

FIG. 6 depicts a side exploded view of the engine shown in FIG. 2;

FIG. 7 depicts a side view of the assembled engine shown in FIG. 2;

FIG. 8 depicts a cross-section through a cross over engine having two pistons driving each magnetic cloverleaf flywheel, illustrating the forced air flow produced by the supercharger which both forces air into the combustion chamber and during the exhaust cycle forces spend fuel out the exterior located exhaust port, this is shown with directional arrows;

FIG. 9 depicts a magnetic cloverleaf flywheel;

FIG. 10 depicts a breakaway bottom view of the engine shown in FIG. 5 illustrating the magnetic cloverleaf flywheels in line and connection with two pistons;

FIG. 11 depicts a top and side perspective view of the ignition module;

FIG. 12 depicts a bottom and side perspective view of the ignition module;

FIG. 13 depicts a top view of the ignition module;

FIG. 14 depicts a cutaway side view of the ignition module illustrating the electrodes within;

FIG. 15 depicts a bottom view of the ignition module illustrating the firing between electrodes and grounds;

FIG. 16 depicts a top view of the generator housing which contains the multiple disc plate armatures, magnetic fields inside the airless cavity, a power drive shaft rotated by the cross over engine which transfers rotational power through the 90 degree gearbox and into the center shaft of the generator. The generator would be mounted in-between the frame rails of any given vehicle;

FIG. 17 depicts a top cutaway view of FIG. 16 illustrating the stacking arrangement of multiple discs plate armatures within the generator housing;

FIG. 18 depicts a side view cross-section view of FIG. 17 illustrating the input power drive shaft, 90 degree gearbox to the generator center shaft and the series of clockwise rotating and counter rotating disc plate armatures. Every other disc plate armature spins in the opposite direction of the previous disc plate armature located in the assembly.

FIG. 19 depicts a top and side exploded view of a single wheel drive assembly;

FIG. 20 depicts a top view cross-section through the wheel drive assembly illustrating the electrical drive motor which can be used for braking by applying reverse voltage, the electrical drive motor gears which transfer rotational power to the wheel axle and a mechanical braking flywheel with its circular braking disc counterpart.

FIG. 21 depicts a side view cross-section taken from the gear side of the wheel drive assembly in FIG. 20. These two gears transfer power from the electric motor to the wheel drive shaft;

FIG. 22 depicts a side view taken from the electric motor and mechanical braking system side of the wheel drive assembly of FIG. 20;

FIG. 23 depicts an outer brake housing which is slotted for the movable brake flywheel. The multiple movable braking flywheels are non-rotational and have outer tabs which fit into the brake housing slots to keep them from rotation but are able to move back in forth in the housing. In-between each braking flywheel is a circular braking disc which rotates on the wheel drive shaft. These circular braking discs have braking compound on both sides. During the braking operation, mechanical force pushes the outer pins or plungers into the non-rotating but movable braking disc flywheels. Once the braking flywheels come into contact with the circular braking discs they slow and then stop the rotating circular braking discs which are located on the wheel shaft, which then slows and then stops the vehicle.

FIG. 24 depicts an open brake housing before the assemble of braking flywheels and circular braking discs are installed;

FIG. 25 depicts a bottom and side perspective view of an alternate braking system which can be used where electric drive units are not used or as conversion system for current production vehicles. These alternate braking systems use a rotor which has braking compound attached to both sides of the rotor. To stop the rotor rotation and thereby the attached wheel, a mechanical caliper device is used which has metal pads or other compound material which compresses against the rotor which has braking compound on both sides. This alternate braking system operates opposite of current production steel rotor and brake compound pads that are compressed against the steel rotor by a mechanical caliper. Brakes fail because of the brake pad overheating. In this alternate braking system, the braking compound surface is on the rotor instead and the conventional braking pads. With the braking compound on the rotor, braking surface is increased many times reducing heat and brake pad fade and failure due to overheating;

FIG. 26 depicts a front view of the alternate braking system described in FIG. 25;

FIG. 27 depicts a side view of the alternate braking system described in FIG. 25;

FIG. 28A depicts a cross-section view of the alternate braking system described in FIG. 25 and shown in FIG. 27;

FIG. 28B depicts an enlarged cross-section view of the mechanical calipers which compress the steel pads or other compound materials into the rotor which has braking compound on both sides as shown in FIG. 28A;

FIG. 29 depicts a front view of a retrofittable braking conversion system and is similar to the brake system and operation shown in FIG. 23;

FIG. 30 depicts a side view of the a retrofittable braking conversion system shown in FIG. 29;

FIG. 31 depicts a cross-section view of the a retrofittable braking conversion system shown in FIG. 30; FIG. 31 is further explained and depicts an outer brake housing which is slotted for the movable brake flywheel. The multiple movable braking flywheels are non-rotational and have outer tabs which fit into the brake housing slots to keep them from rotation but are able to move back in forth in the housing. In-between each braking flywheel is a circular braking disc which rotates on the wheel drive shaft. These circular braking discs have braking compound on both sides. During the braking operation, mechanical force pushes the outer pins or plungers into the non-rotating but movable braking disc flywheels. Once the braking flywheels come into contact with the circular braking discs they slow and then stop the rotating circular braking discs which are located on the wheel shaft, which then slows and then stops the vehicle;

FIG. 32A depicts a perspective view of a circular braking disc plate assembly with braking compound affixed to both sides of the braking disc plate; and

FIG. 32B depicts a side view of the reverse side of the circular braking disc plate assembly shown in FIG. 32A with braking compound affixed to both sides of the braking disc.

### DETAILED DESCRIPTION OF THE PREFERRED EMBODIMENTS

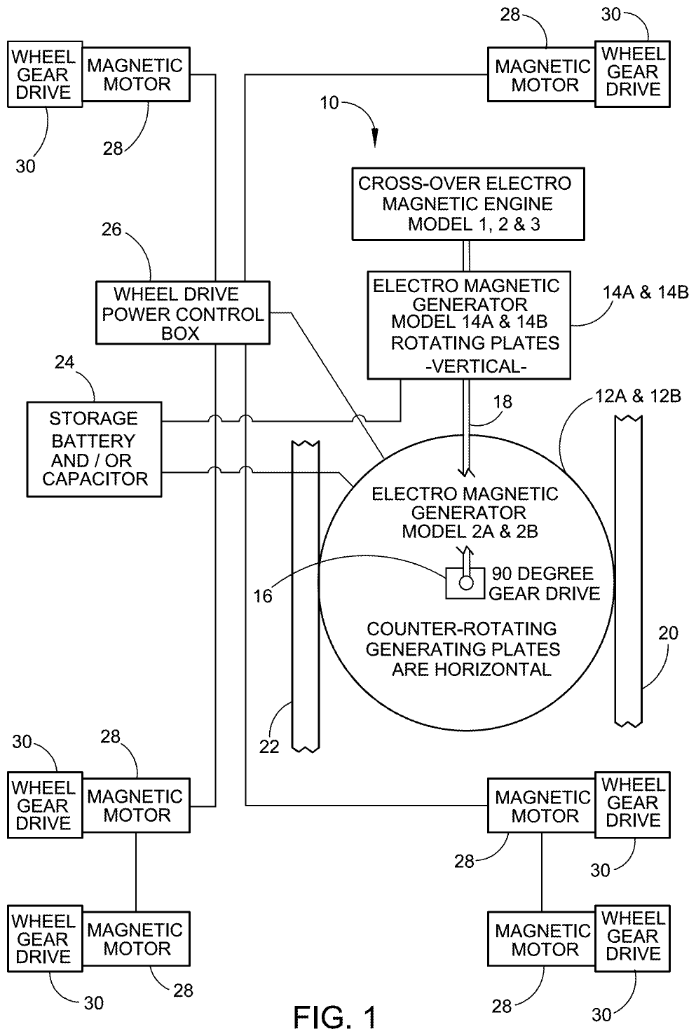

For a fuller understanding of the nature and objects of the invention, reference should be had to the following detailed description taken in conjunction with the accompanying drawings wherein similar parts of the invention are identified by like reference numerals. There is seen in FIG. 1 a schematic diagram of the cross-over engine overall vehicle layout showing an Electro-Magnetic Engine system 10 driving either an electromagnetic generator 14A or 14B with vertical rotating plates, or an electromagnetic generator 12A or 12B having horizontal counter-rotating generating plates connected to a 90 degree gear drive 16 for rotating drive shaft 18. Electromagnetic generator 14A or 14B mounts on the backside of the Electro-Magnetic Engine system 10, whereas the electromagnetic generator 12A or 12B mounts in between the vehicle frame rails 20 and 22. The Electro-Magnetic Engine system 10 is designed to operate using electromagnetic forces to power engine movement. Fossil fuels may also be used in conjunction to force engine movement.

FIG. 1 illustrates that the electromagnetic generator 12A or 12B is connected to both the storage battery and/or capacitor 24 and the wheel drive power control box 26, while the electromagnetic generator 14A or 14B is connected to the storage battery and/or capacitor 26. The wheel control box 26 is connected to two or more magnetic motors 28 each of which are connected to a wheel gear drive 30. As shown in FIG. 1, six magnetic motors 28 each are connected to six wheel gear drives 30.

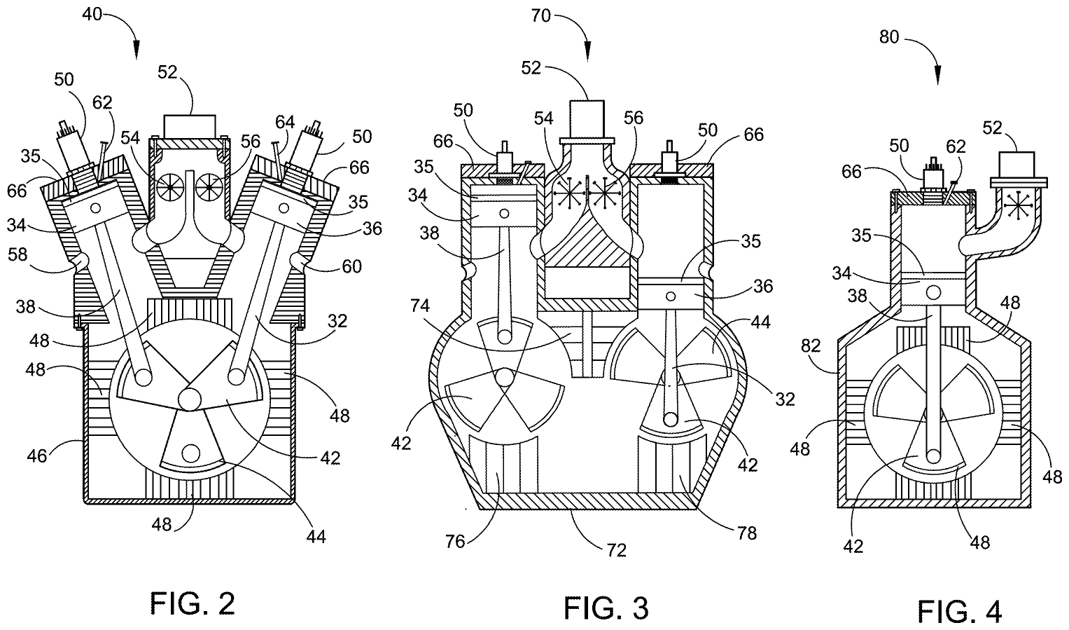

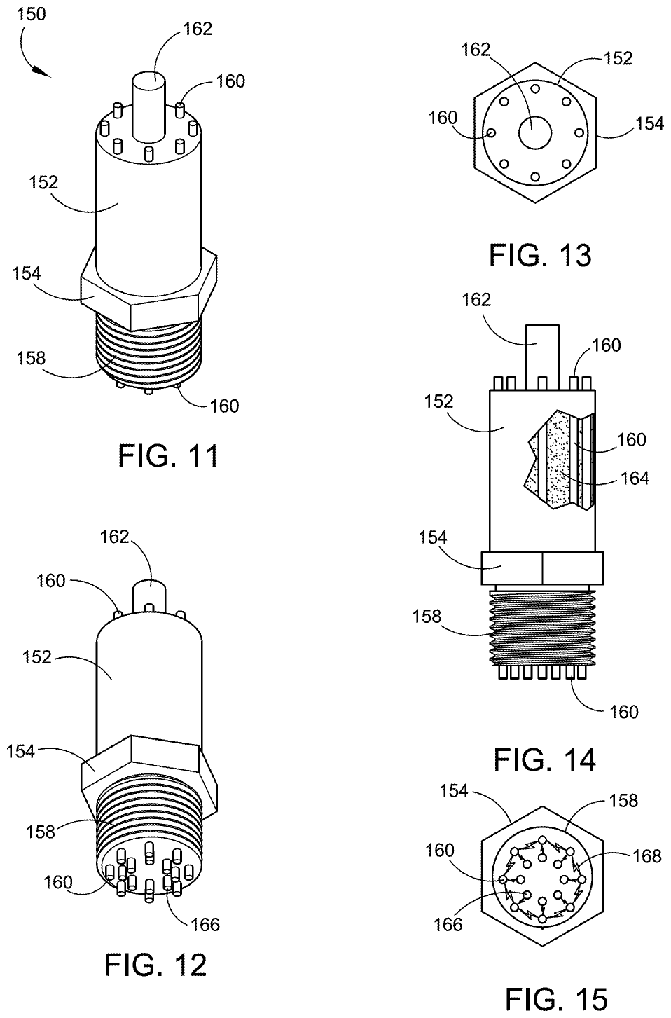

Referring now to FIG. 2 there is shown a cross-section view through an engine, Model #1, having a non-magnetic engine block 40 housing two pistons 34 and 36, having two piston rods 38 and 32 connected to one magnetic cloverleaf flywheel 42. Each lobe of magnetic cloverleaf flywheel 42 has a magnet array 44 on the surface of its distal end. Crankcase 46 is lined with two or more magnetic arrays 44, here four magnetic arrays 44 are shown within the crankcase 46. Each engine also includes one or more electromagnetic ignition modules 50, an air intake regulator 52, one or more air turbine blades 54 and 56 which direct air induction, one or more cross-fire combustion ports 58 and 60 and one or more fuel atomizer/injectors 62 and 64. The electromagnetic head 66 is powered to force the pistons 34 and 36 down and pull the pistons up. In each engine model there is a magnetic piston top surface 35 and each cylinder head is a magnetic head 66 which can be alternately electronically polarized in the north or south polarity to create magnetic force to move the piston up and down, and assist in that up-down motion to generate power in a more efficient manner. Ignition module 50 has a central electrode (see FIGS. 11-15 and centrally located electrode pin 162).

In FIG. 3 there is shown a cross-section view through an engine, Model #2, having a non-magnetic engine block 70 housing two pistons 34 and 36, having two piston rods 38 and 32 connected to two magnetic cloverleaf flywheels 42 each having a magnetic array 44 on the distal end of each flywheel lobe. The double crankcase 72 houses three electromagnetic liners 74, 76 and 78 to be charged and timed to rotate the two crankshafts.

In FIG. 4 there is shown a cross-section through an engine, Model #3, having a non-magnetic engine block 80 housing one piston 34 driving one magnetic cloverleaf flywheel 42. Here the single crankcase 82 is lined with four magnetic arrays 48.

Electromagnetic engines can use traditional pistons, rotary type internal propulsion methods such as a Wankel rotary engine or aircraft turbine or jet propulsion to produce power through use of electromagnetic forces applied to the internal spinning circular discs. It is anticipated that all models will have an all magnetic piston or a piston including a magnetic top surface, and a cylinder head with power provided to create an alternating north/south polarity in the magnetic head.

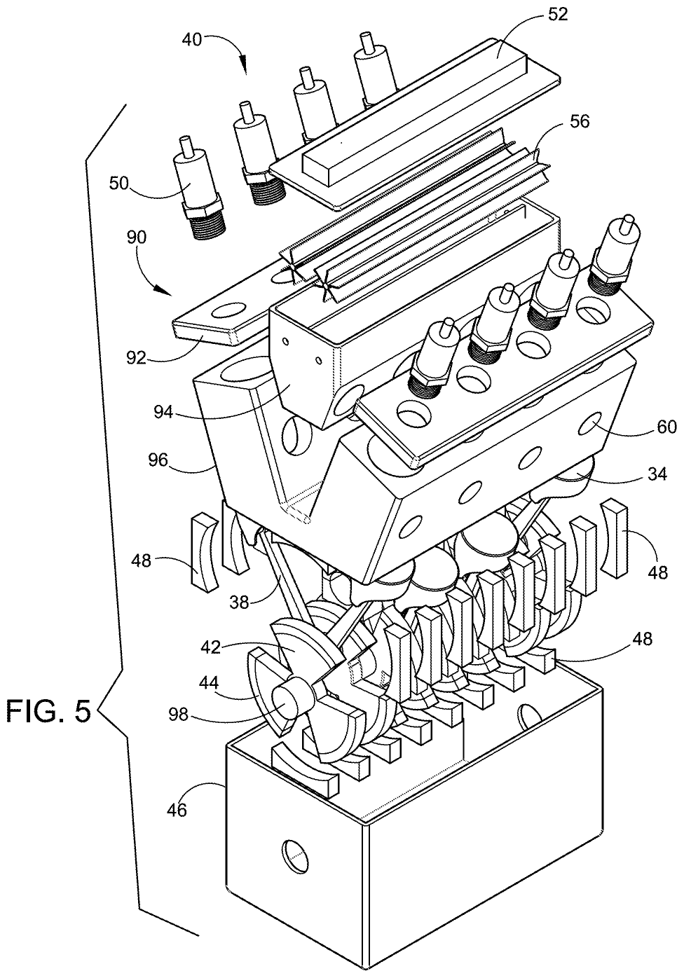

FIG. 5 depicts a front perspective exploded view of the cross-over electro-magnetic engine 40 shown in FIG. 2. Here, there are eight pistons in a V8 configuration, with each set of two pistons 34 utilizing piston rods 38 driving a pair of magnetic cloverleaf flywheels 42 having a magnetic surface 44 on the distal end. This FIG. 5 also illustrates the upper portion 90 of the engine 40 showing the magnetic head 92 for mounting the ignition modules 50, positioned above the main engine piston cylinder housing 96 (having one air intake and exhaust port per piston cylinder) and adjacent to the air intake frame 94. Eight pistons drive four sets of two connected cloverleaf flywheels within crankcase 46 lined with four magnetic arrays 48 to turn crankshaft 98.

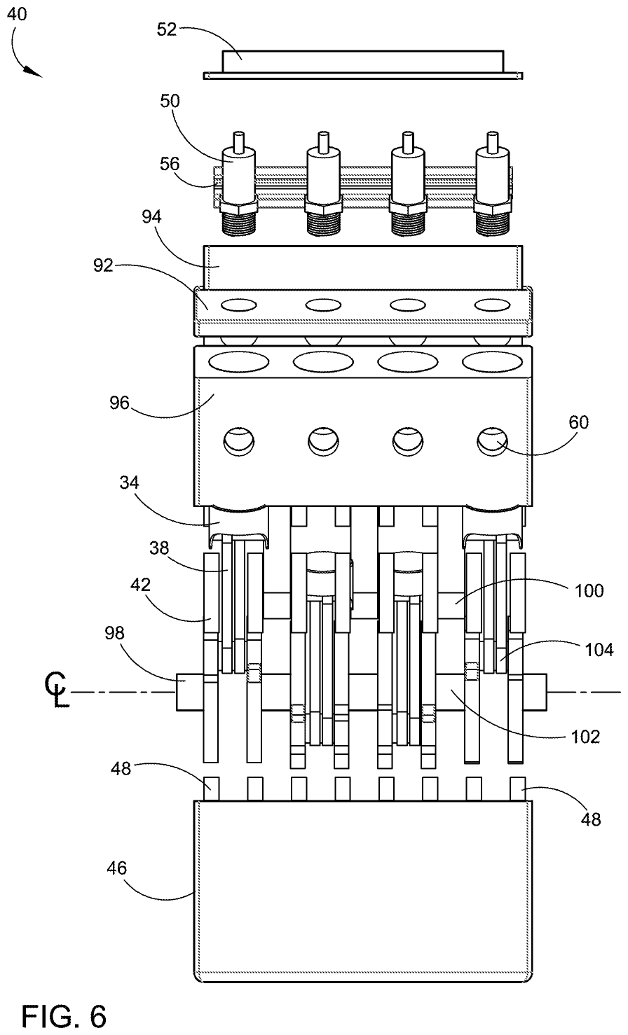

FIG. 6 depicts a side exploded view of the engine shown in FIG. 5 and illustrates how the cloverleaf flywheel pairs are connected to the piston rod 38 by connecting rod bearing 104 and linked together as a pair of cloverleaf flywheels 42 using offset connecting rod bearings 100 and 102.

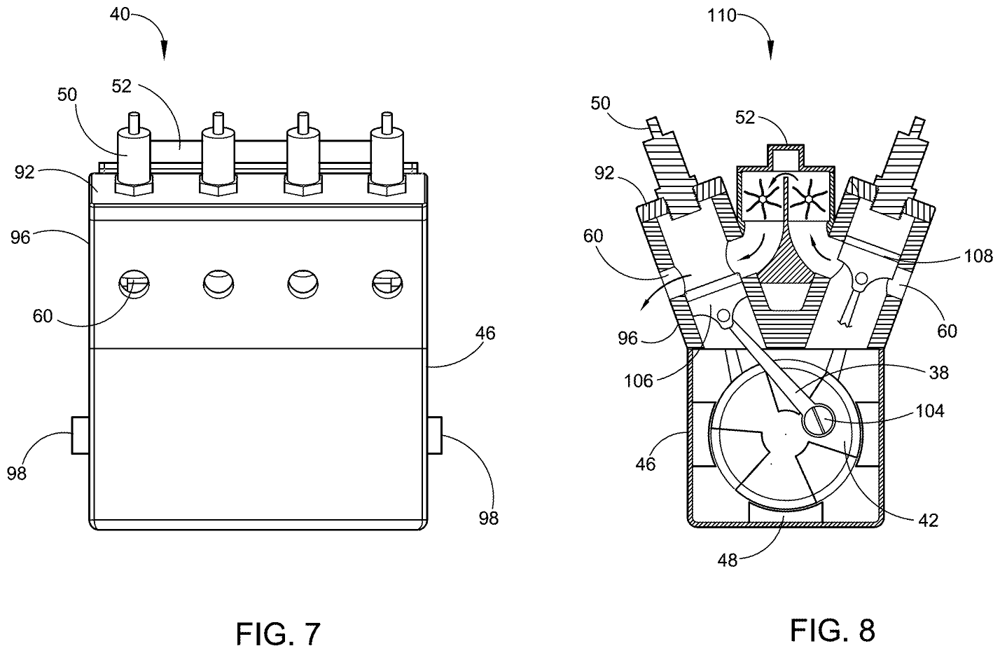

FIG. 7 depicts a side view of the assembled engine shown in FIG. 5 illustrating that the crankshaft 98 protrudes from each end of crankcase 46, and that for every piston cylinder (not shown) there is an individual ignition module 50 and having one air intake and exhaust port per piston cylinder.

FIG. 8 depicts a cross-section through an engine 110 having two pistons 106 and 108 driving each magnetic cloverleaf flywheel 42, illustrating the having one air intake and exhaust port showing air flow with directional arrows. When piston 106 is in the down position after combustion and piston 108 is in the up position compressing fuel pre-combustion, air flows from the air intake turbines and into the piston 106 cylinder before exiting out the exhaust port 60.

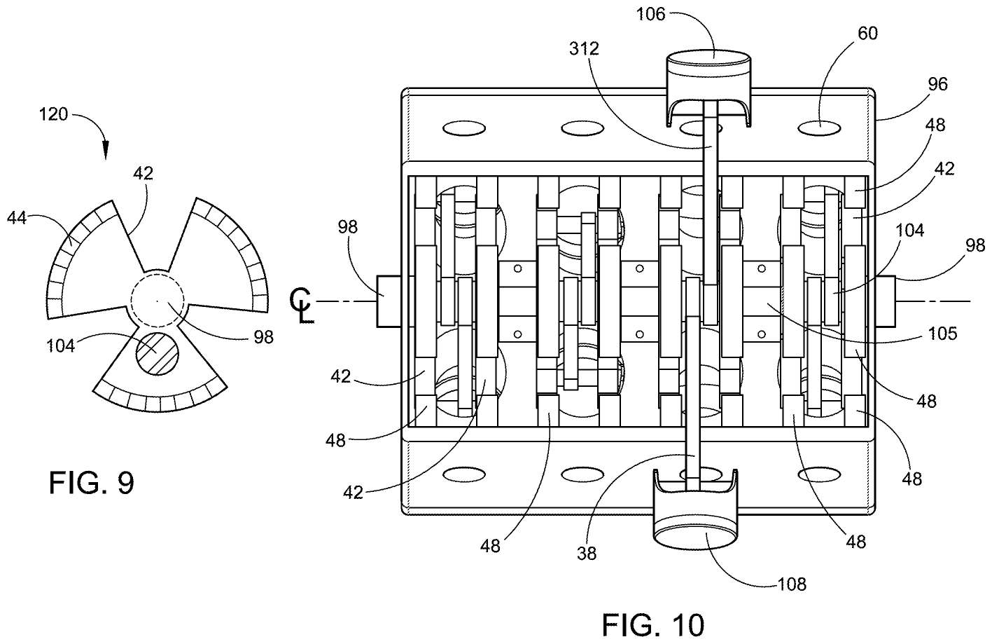

FIG. 9 depicts a magnetic cloverleaf flywheel 120 having a three-lobe flywheel configuration 42 rotating about centerline crankshaft 98 (not shown but outlined here). Each lobe of flywheel 42 has a magnetic array 44 on its distal end. Flywheel 42 is connected to piston rods (not shown) by connecting rod bearing 104.

FIG. 10 depicts a breakaway bottom view of the engine shown in FIG. 5 illustrating the magnetic cloverleaf flywheels 42 in line and connection with two pistons 106 and 108 through piston rods 32 and 38. Cloverleaf flywheels 42 are connected to piston rods 32 and 38 at rotating cloverleaf bearing 104. Cloverleaf flywheels 42 are arranged in pairs connected to the centerline crankshaft 98 by crankshaft bearings 105.

In a piston operated electromagnetic engine, magnetic forces both push the piston down and reverse magnetism retracts or pulls the piston upwards. In addition, the crankshaft rotation shall also be assisted by electromagnetic forces. To accomplish the crankshaft electromagnetic assisted rotation, this engine shall have several clover leaf flywheels located along the length of the crankshaft. These clover leaf flywheels have independent lobes and at the outer surface of these lobes, have a segmented magnetic fields located on the outer edge of each lobe. Surrounding each cloverleaf flywheel are electromagnetic fields which are energized in sequence to pull and push the cloverleaf flywheels in a circular motion with magnetic forces.

In the piston operated electromagnetic engines, transferring of combustion forces (exhaust gases) can be transferred to a turbo motor which can assist the crankshaft rotation or can be used to power onboard generators, air conditioning units, etc. The exhaust turbo motors will employ the use of planetary gear reduction to maximize output shaft power and torque. In addition, exploded fuel creates a fiery exhaust, this fiery exhaust can be piped into another piston approaching the combustion position. The fiery injection into an opposing piston ready to fire will aid in a more efficient burn of the atomized fuel. The use of intake or exhaust valves are not required in the design of the piston engine but can be used. The intake and exhaust cycles of the piston engine are accomplished by cylinder porting. Engine intake air is forced into the cylinder chamber and exhaust gases are forced out of the cylinder chamber by a supercharger located on or attached to the engine when the engine piston is at the bottom of the piston stroke.

In the piston operated electromagnetic engines, the pistons can be flat top, concave, domed or pointed domed pistons. Cylinder walls and pistons are non-magnetic materials. The top of the piston has a magnetic material or magnet. The cylinder heads of the piston operated electromagnetic engines have an electromagnetic surface which produces both north (positive pull) or south (negative push) magnetic power fluctuating to assist piston movement in a up or down stroke. The engine block shall be non-magnetic material.

In the piston operated electromagnetic engines, there can be multiple crankshafts for boosting engine power. All crankshafts are designed with multiple circular non-magnetic cloverleaf flywheels or discs spaced along the length of the crankshaft which have electromagnetic lobes attached around the circumference of the flywheels. These lobes are attracted to the external electromagnetic field surrounding the non-magnetic cloverleaf flywheels with magnetic lobes. This magnetic attraction causes the crankshaft to turn using a similar principal as an electric motor.

In the piston operated electromagnetic engines, during use of fossil fuel, the atomized fuel shall be injected into the combustion chamber by pump actuated injectors. The atomized fuel shall be ignited at the top of the compression stroke by the means of an electromagnetic ignition module. This ignition module works similar to a spark plug but instead of one spark to ignite the fuel, the ignition module produces multiple high flash circular spark bands all at one instance.

In the piston operated electromagnetic engines, pistons can be arranged in a vertical inline arrangements, v-inline arrangements, flat or horizontal arrangements or any of the above noted arrangements using multiple crankshafts in one engine. In the piston operated electromagnetic engines, piston count can be one or multiple pistons operating in one engine.

Wankel and jet turbine engines can use the same electromagnetic power applied to the internal rotating discs normally powered by fossil fuels only. The rotating discs shall have magnetic lobes at the perimeter of the disc. Around the discs is an electromagnetic field attached to the outer circular engine case producing magnetic power ahead of the magnetic lobes on the rotating discs. Magnetic power rotates the circular discs by alternating power ahead or behind of the magnetic lobes located on the outer rim of the internal discs. On any engine, but especially jet engines and Wankel engines every other circular disc can be on planetary gears causing opposite rotation of every other disc. All lobes located on the outer perimeter will be weighted to create centrifugal force movement.

Electromagnetic engines shall power the generator which shall employ the use of circular counter rotating disc plate armatures. The use of counter rotating circular disc armatures within the generator will create a gyro affect at high speed rotation which will stabilize a vehicle and provide resistance from rollover accidents. Counter rotating circular disc generators are not limited to vehicle use. They will and can be used in any commercial or household power generation requirement. These counter rotating electromagnetic generators can be converted over to electric motor use by providing an outside electrical power source.

All electric producing generators or motors shall employ a circular weighted disc plate armature for internal power generation. These electromagnetic disc plates' armatures will be arranged in a back to back series on a common shaft. Each one of these circular disc plates' armatures shall be weighted at the exterior perimeter for centrifugal force energy. Additionally, they will also have electromagnetic lobes attached at the exterior circumference to interact with the circular case containing the electromagnetic fields which will use magnetism to produce electricity by the interaction of the spinning electromagnetic plates. These generators can be used as electric motors by introducing an outside electrical source. Additionally, traditional electric motor coil induction fields can be used.

All internal circular weighted disc plate armatures will be in a series on a common shaft. Every other circular electromagnetic disc plate shall be mounted on planetary gear assembly which will allow every other electromagnetic disc plate to turn in the opposite rotation creating double face to face speeds of the circular electromagnetic disc plate armatures. The circular electromagnetic disc plate armatures will spin at extremely high RPM'S for maximum power output

The interior of the generator housings can be without air or filled with air gases to enhance power generation and provide less resistance to the circular speed of the interior rotating and counter rotating electromagnetic disc plate armatures. Traditional coil fields can be used in conjunction with electromagnetic fields. Power transfer from the electromagnetic engine to the generator by common driveshaft to a right angle gear box which powers the vertical shaft within the generator. The counter rotating generator should be mounted horizontally behind the engine in-between the frame rails of the vehicle. However, it can also be mounted upright where the shaft is horizontal, and the generator connects directly to the backside of the engine. If this method is used, the generator diameter will be limited by available space in the engine bay and firewall area.

FIG. 11 depicts a top and side perspective view of the electromagnetic ignition module 150. The ignition module 150 has a cylindrical housing 152, a hex portion 154 and a threaded portion 158. Electrodes 160 extend through the housing 152 and protrude from the top surface of the housing 152 and the bottom of the threaded portion 158. On top of the ignition module 150 is a centrally located pin 162 for high voltage transfer to the engine head in both north and south magnetic polarity. When in operation, this alternating magnetism creates a force to push the piston down and reverse polarity to pull the piston up.

FIG. 12 depicts a bottom and side perspective view of the ignition module 150 showing a circular array of eight electrodes 160 and an inner circular array of eight ground poles 166 (also see FIG. 15). While these figures show eight electrodes and eight ground poles, any number of electrodes and ground poles may be employed.

FIG. 13 depicts a top view of the ignition module showing the centrally located pin 162 for high voltage transfer to the engine head, and the circle array of electrodes 160 on the top surface of housing 152.

FIG. 14 depicts a cutaway side view of the ignition module 150 illustrating the electrodes 160 within the housing 152 which extend from the top surface of the housing 152 to the bottom surface of the threaded portion 158. The housing 152 is filled with insulation material 164 surrounding each electrode 160 extending therethrough.

FIG. 15 depicts a bottom view of the ignition module 150 illustrating the spark firing 168 between electrodes 160 and ground poles 166. Spark firing 168 may occur between any adjacent outer electrode 160 and any adjacent inner ground pole 166.

In operation, on top of the ignition module 150 you have a large pin 162 in the center. This is for high voltage transfer to the engine head in both north and south magnetic polarity. This alternating magnetism creates a force to push the piston down and reverse polarity to pull the piston up.

Also, on top there are eight smaller electrodes 160. These electrodes 160 are wrapped in insulation 164 and extend through the housing 152 body of the ignition module 150 and protrude out the bottom and are represented by the outer ring. The cutaway illustration of FIG. 14 shows this and the insulation around each electrode. These eight electrodes are individually electrified during the ignition cycle. The inner circle of ground poles are simple grounds. So, during ignition, eight separate electrical charges are sent through the outer ring electrodes 160 to the base of the module (bottom surface of threaded portion 158) at which point the spark 168 jumps from the power electrodes 160 to the ground poles 166 creating multiple sparks 168. Any combination of power to ground electrodes can be used in this assembly for this operation. For example, every other electrode can be power and the other ground. No matter how the arrangement of power to ground is set up the final result is the same, multiple sparks 168 for advanced combustion. Also noted here is that the body of the ignition module 152 from the hex nut portion 154 and up would be insulating material, such as all porcelain glass or equivalent. Any nonconductive material can be used for example carbon fiber, resins, and the like.

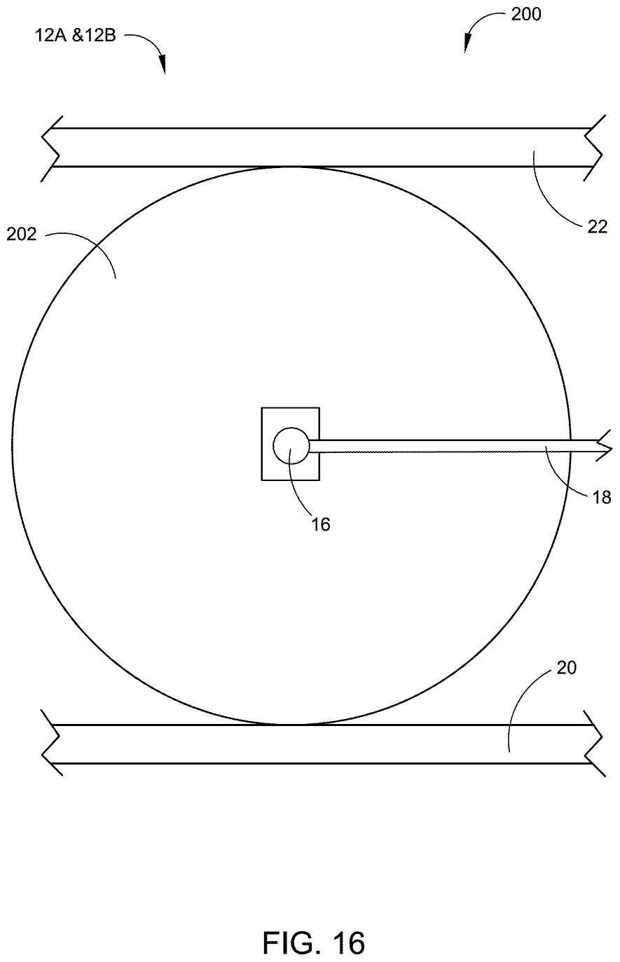

Turning now to the electromagnetic generators 12A and 12B, there is shown in FIG. 16 a housing of horizontally configured magnetic counter-rotating generating rotating discs and magnetic fields inside an airless cavity having a 90 degree gearbox 16 and power drive shaft 18, mounted on the frame rails 20 and 22 of a vehicle.

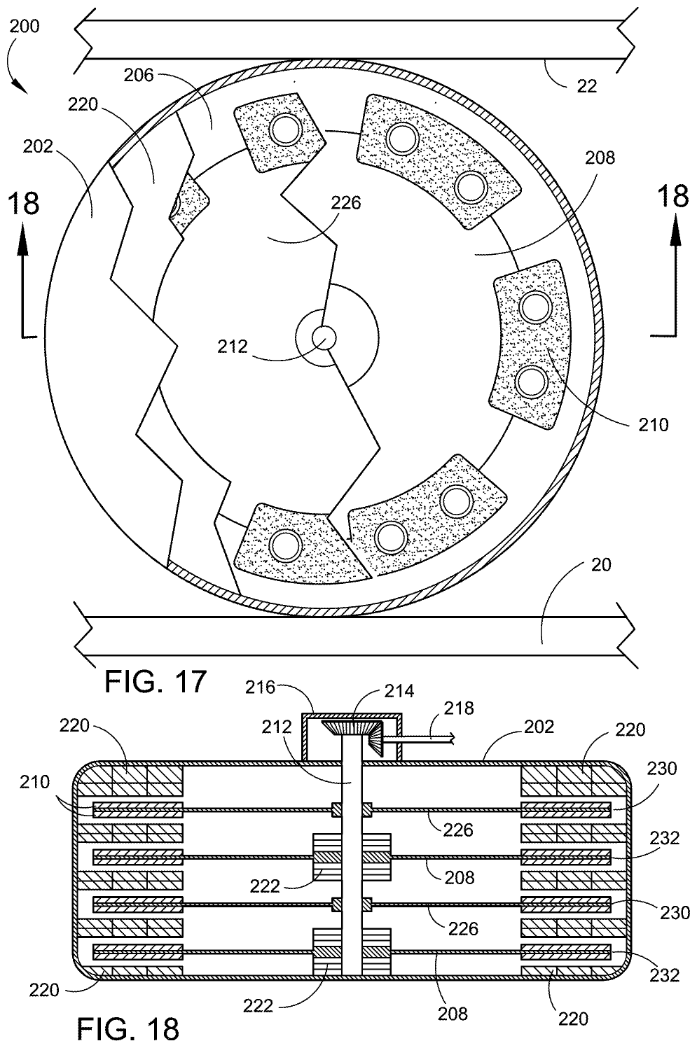

FIG. 17 depicts a multiple cutaway view of FIG. 16 illustrating the array of horizontal disc plate armatures 208 within the housing 200, showing the airtight case outer housing 202 mounted horizontally between tow vehicle frame rails 20 and 22. The disc plate armatures 208 and the stationary magnetic fields 220 are housed within the airless cavity 206. The disc plate armatures 208 spin around a centrally located center power shaft 212.

FIG. 18 depicts a side cross-section view of FIG. 17 illustrating the horizontal spinning disc plate armatures within cavity 202. These counter-rotating discs 208 travel in the clockwise 230 and counterclockwise 232 directions in alternating horizontal disc plate armatures 208 and 226 within the airless cavity 206. Counter clockwise rotating disc plate armatures 232 are connected to center power shaft 212 through planetary gears 222. These planetary gears 222 enable reverse rotation of the discs 208. All disc plate armatures 208 and 226 spin and drive center power shaft 212 which transfers power to a power input shaft 218 through the 90 degree gearbox 216 housing gear 214. All disc plate armatures have a plurality of electromagnets 210 on the outer circumference, and these electromagnets align with the stationary magnetic fields 220 within the airless cavity 206. All magnets used can be of the stationary, rare earth magnets, or electromagnetically activated magnets.

Electromagnetic engines shall power the generator which shall employ the use of circular counter rotating disc plate armatures. The use of counter rotating circular disc plate armatures within the generator will create a gyro affect at high speed rotation which will stabilize a vehicle and provide resistance from rollover accidents. Counter rotating circular disc generators are not limited to vehicle use. They will and can be used in any commercial or household power generation requirement. These counter rotating electromagnetic generators can be converted over to electric motor use by providing an outside electrical power source.

All electric producing generators or motors shall employ a circular weighted disc plate armature for internal power generation. These electromagnetic disc plates' armatures will be arranged in a back to back series on a common shaft. Each one of these circular disc plates' armatures shall be weighted at the exterior perimeter for centrifugal force energy. Additionally, they will also have electromagnetic lobes attached at the exterior circumference to interact with the circular case containing the electromagnetic fields which will use magnetism to produce electricity by the interaction of the spinning electromagnetic plates. These generators can be used as electric motors by introducing an outside electrical source. Traditional electric motor coil induction fields can be used.

All internal circular weighted disc plate armatures will be in a series on a common shaft. Every other circular electromagnetic disc plate shall be mounted on planetary gear assembly which will allow every other electromagnetic disc plate to turn in the opposite rotation creating double face to face speeds of the circular electromagnetic disc plate armatures. The circular electromagnetic disc plate armatures will spin at extremely high RPM's for maximum power output.

The interior of the generator housings can be without air or filled with air gases to enhance power generation and provide less resistance to the circular speed of the interior rotating and counter rotating electromagnetic disc plate armatures.

Traditional coil fields can be used in conjunction with electromagnetic fields.

Power transfer from the electromagnetic engine to the generator by common driveshaft to a right angle gear box which powers the vertical shaft within the generator. The counter rotating generator should be mounted horizontally behind the engine in-between the frame rails of the vehicle. However, it can also be mounted upright where the shaft is horizontal, and the generator connects directly to the backside of the engine. If this method is used, the generator diameter will be limited by available space in the engine bay and firewall area.

Electric energy produced by the counter rotating disc plate generator shall be transferred to electric motor wheel gear drives.

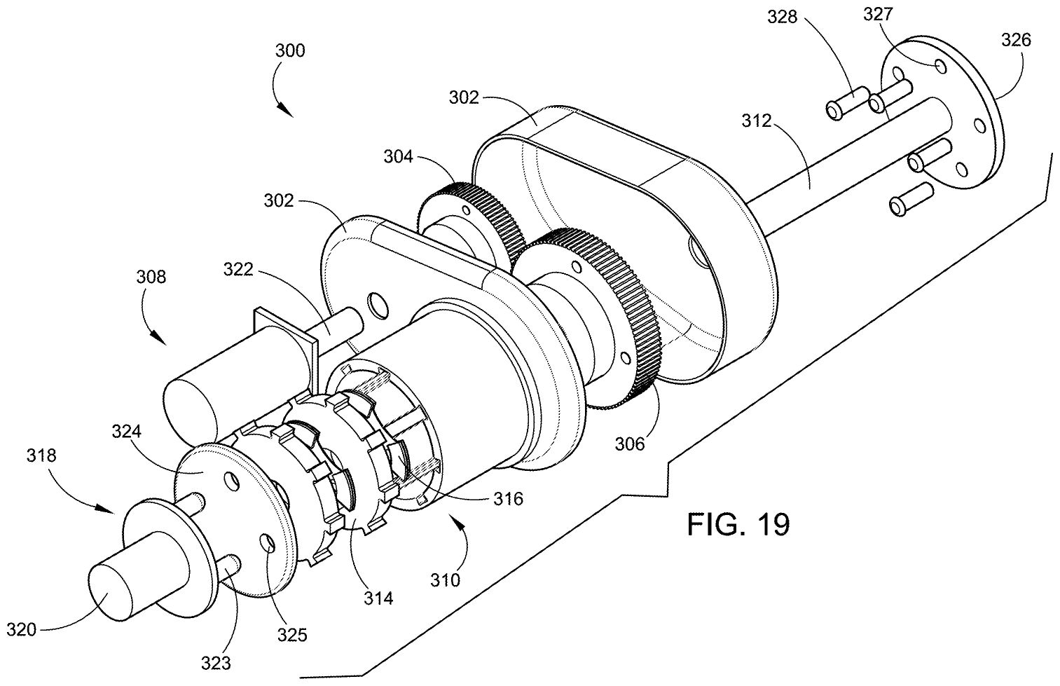

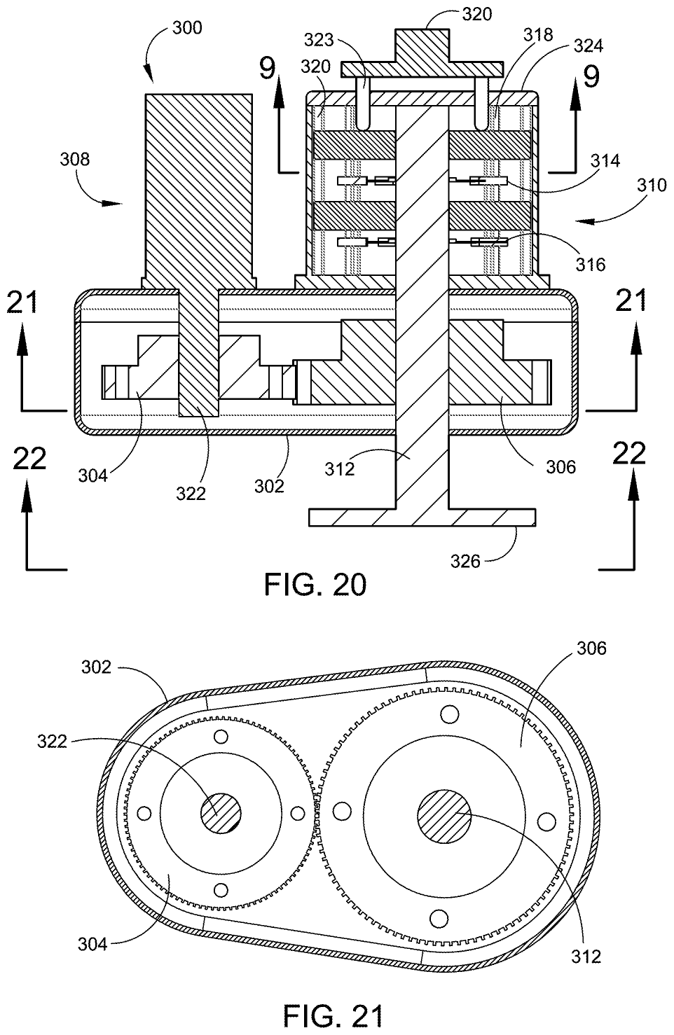

Turning now to the wheel drive assemblies, FIG. 19 depicts a top and side exploded view of a single engine wheel drive assembly 300. This exploded view of wheel drive assembly 300 illustrates the drive housing 302 which connects to the electric motor assembly 308 and houses electric motor drive gear 304 and wheel drive gear 306. Drive housing 302 also houses the mechanical brake system assembly 310. Both the electric motor assembly 308 and the mechanical brake system assembly 310 are shown in greater detail in FIG. 20. The electric motor assembly 308 includes an electric motor shaft 322. The mechanical brake system assembly 310 includes a hydraulic ram actuator assembly 318 having a hydraulic piston 320 and brake actuator ram shafts 323 passing through ram shaft openings 325 on a housing endcap 324. Within the mechanical brake system assembly 310 there is shown the position of the stationary braking flywheel discs 314 and the braking disc plates 316. Located at the distal end of driveshaft 312 is a wheel mounting plate 326 having wheel lug openings 327 for accepting wheel lugs 328.

FIG. 20 depicts a top cross-section view through the wheel drive assembly 300 illustrating the electric motor assembly 308 and houses electric motor drive gear 304 and wheel drive gear 306, the mechanical braking system 310 within housing 302. Within the mechanical brake system assembly 310 there is shown the position of the stationary braking flywheel discs 314 and the braking disc plates 316 in relation to a center power and braking shaft 312.

In operation, hydraulic piston 320 forces brake actuator ram shafts 323 passing through ram shaft openings 325 to press against stationary braking flywheel discs 314 and those in turn push up against the braking disc plates 316 slowing the rotation of center power and braking shaft 312 and thus slowing the vehicle. The braking surface on the braking disc plates is about 50 times greater than with conventional brakes having a typical brake pad and caliper arrangement. Having 50 time greater surface for braking, this enables the brakes to function more effectively, generate less heat, and have a greatly lowered failure rate, which makes this braking system suited for semi's and other large vehicles where brake failure is an ongoing issue.

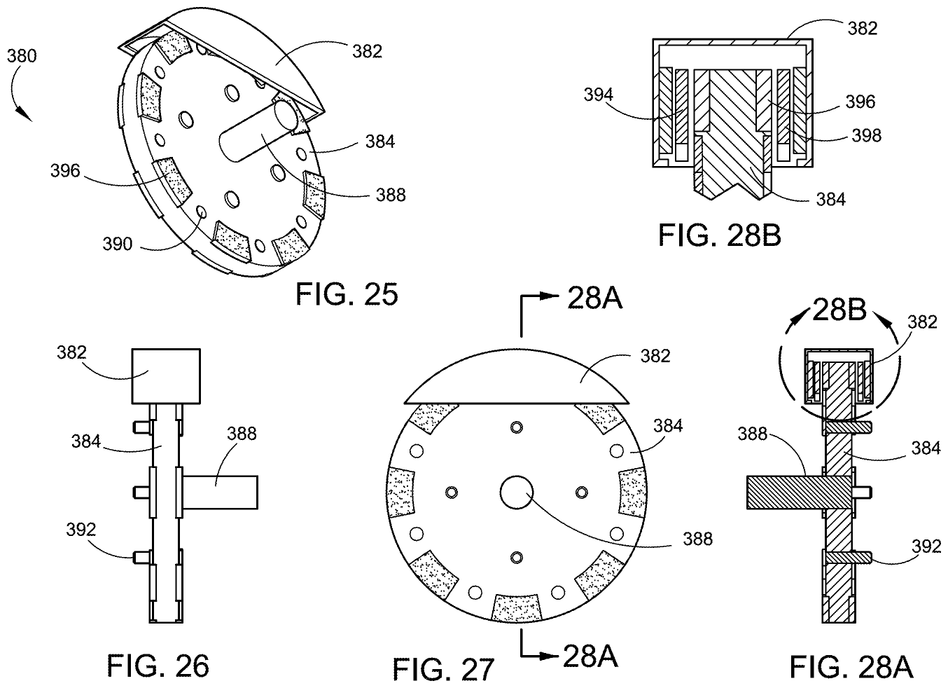

Wheel gear drives shall employ an electric reverse power system for braking. Reverse polarity in the electromagnetic drive motor will create a reverse rotation force in the motor which will act as a braking force. In addition, an alternate mechanical brake system shall be incorporated in the electric motor gear drive (see FIGS. 25-28B).

FIG. 21 depicts a cross-section taken through the wheel drive assembly in FIG. 20 illustrating the configuration of electric motor drive gear 304 and wheel drive gear 306 housed within housing 302 and their relation to the electric motor shaft 322 and center power and braking shaft 312.

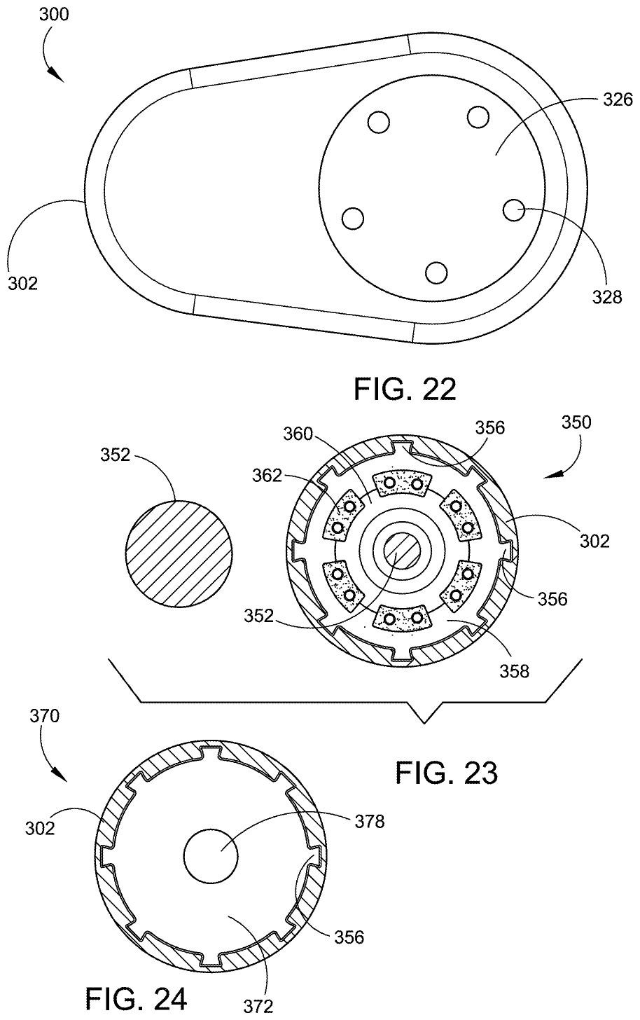

FIG. 22 depicts a side view of the assembled wheel drive assembly of FIG. 20 illustrating the wheel mounting plate 326 and wheel lugs 328.

FIG. 23 depicts detail of a brake housing 350 having a movable brake flywheel disc 360 therein, and illustrating the stationary braking flywheel (not shown) mounting slots 356 located around the circumference of the brake housing. The braking disc 360 is located within housing cavity 358 and has numerous braking compound elements 362 located around its circumference.

FIG. 24 depicts an empty brake flywheel housing 370 with integrated stationary braking flywheel (not shown) mounting slots 356 located around the circumference of the brake housing. These slots 356 are for accepting stationary braking flywheel locking pins within cavity 372.

FIG. 25 depicts a bottom and side perspective view of an alternate mechanical brake system 380 which may be incorporated in the electric motor gear drive, having a traditional brake caliper 382 partially covering a braking disc 384. Around the circumference of the braking disc 384 are a number of braking compounds 396 and ventilation holes 390 for cooling. Also shown is wheel center axle 388.

FIG. 26 depicts a front view of the mechanical brake system 380 also illustrating the location of the wheel lugs 392.

FIG. 27 depicts a side view of the back-up mechanical brake system 380 also illustrating the braking disc 384 in relation to the caliper 382 and wheel center axle 388.

FIG. 28A depicts a cross-section view of the mechanical brake system 380 also illustrating the braking disc 384 in relation to the caliper 382 and wheel center axle 388 shown in FIG. 27. Wheel lugs 392 pass through braking disc 384.

FIG. 28B depicts an enlarged cross-section view of the back-up mechanical brake system 380 also illustrating the braking disc 384 in relation to the caliper 382 and wheel center axle 388 shown in FIG. 27. Braking compound 396 is located on braking disc 384. When the traditional brake caliper 382 is actuated, the brake pads 398 press against braking compound 396 causing the vehicle to slow down. The braking surface on the braking disc plates is about 50 times greater than with conventional brakes having a typical brake pad and caliper arrangement. Having 50 time greater surface for braking, this enables the brakes to function more effectively, generate less heat, and have a greatly lowered failure rate, which makes this braking system suited for semi's and other large vehicles where brake failure is an ongoing issue.

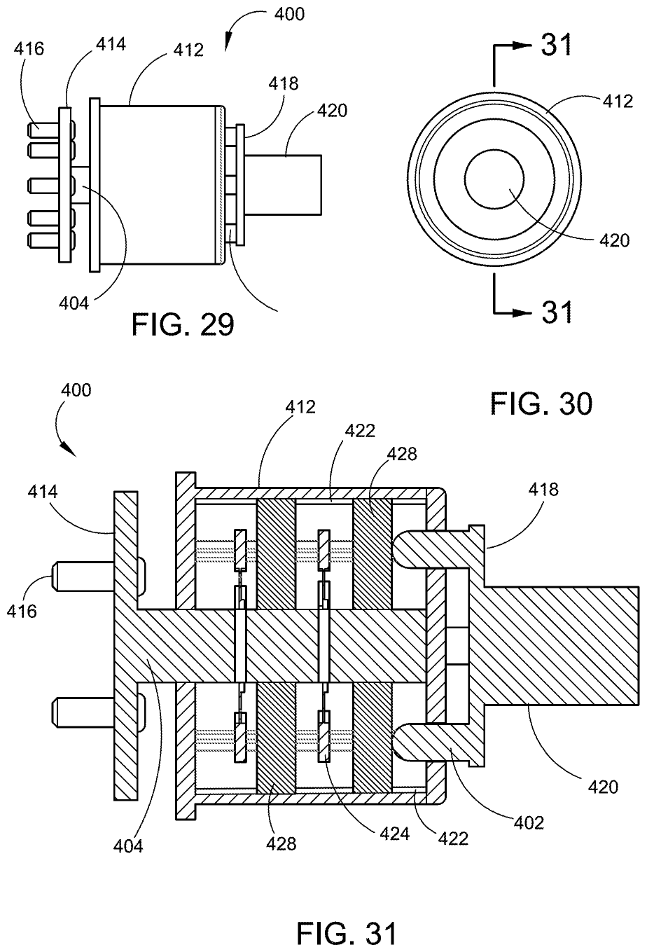

FIG. 29 depicts a front view of a retrofittable braking conversion system 400 which is capable of replacing traditional brakes on vehicles, especially suited for large and heavy vehicles such as semi's, tractor trailers, etc. The retrofittable braking conversion system 400 is housed within casing 412 and includes hydraulic brake actuator 420 and braking rams 402 mounted on endcap 418. Center power and braking shaft 404 is connected to wheel mounting plate 414 and wheel mounting plate 414 has a plurality of wheel lugs 416 mounted thereon.

FIG. 30 depicts a side view of retrofittable braking conversion system 400 showing the casing 412 and the hydraulic actuator assembly 420.

FIG. 31 depicts a cross-section view of the retrofittable braking conversion system 400 illustrating the position of the stationary braking discs 428 and rotating braking discs 426 within the casing 412. In operation, hydraulic actuator piston assembly 420 forces actuator rams 402 to press on stationary braking discs 428 which in turn presses against rotating braking discs 424, slowing the vehicle. Stationary braking discs 428 slide along grooves 422 within the casing 412 to move into contact with rotating braking discs 424.

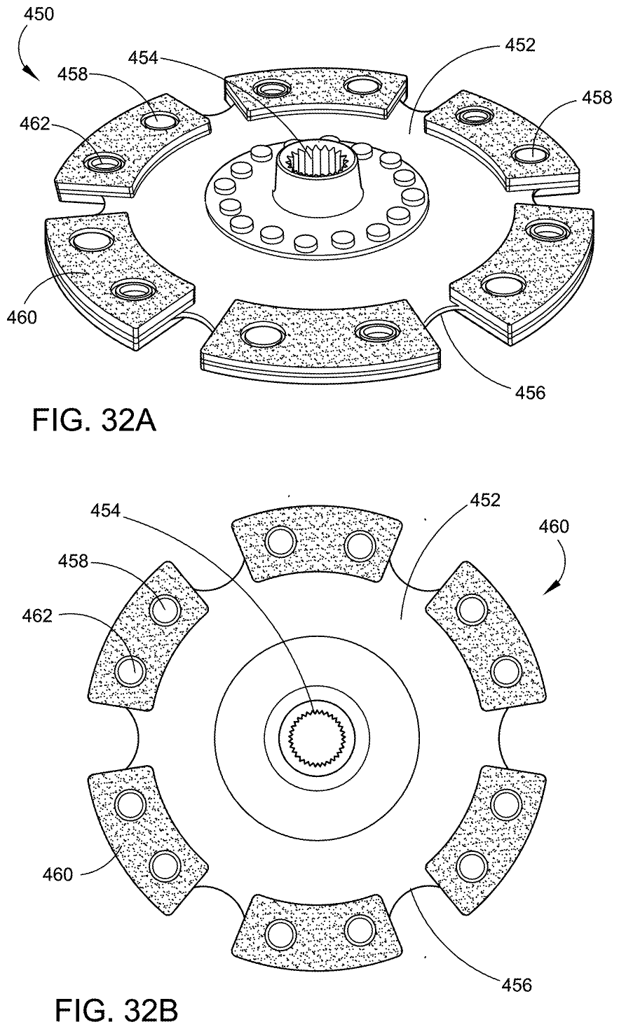

FIG. 32A depicts a brake disc plate assembly 450 having a braking disc 452 with multiple braking compound units 460 affixed to both sides of the braking disc plate 452 surrounding its circumference. In the center of the braking disc 452 is a spline shaft opening 454. The braking compound units 460 are mounted using rivets 458 and 462 and have cooling gaps 456 interspersed between the braking compound units 460.

FIG. 32B depicts a reverse side view of the reverse side of the brake disc plate assembly 450 shown in FIG. 32A illustrating that the braking compound units 460 are affixed to both sides of the braking disc 452 using rivets 458 and 462.

The alternate mechanical brakes shall be a combination of full circle brake discs with braking compounds attached to both faces and opposing flywheels. The full circle braking discs with braking compounds will be compressed against the opposing flywheels by hydraulic means and upon contact will arrest movement of the gear drive unit. These braking systems can be dry or liquid bath. Current pad and rotor systems or drum type braking systems can be converted over to the full circular disc and flywheel system on all current production vehicles and any machinery device requiring rotation speed braking.

The entire vehicle drive system shall be controlled by an electronic control box to vary speed and voltage to the vehicle electric wheel drive units. When the electric wheel gear drive and full circular braking disc and flywheel braking systems are used in a vehicle, during a left hand turn the, the left side electric gear drive motors are depowered, and the right side electric wheel gear drive motors receive additional power to assist the vehicle's left hand turns. This is especially helpful in off road dirt racing. When the electric wheel gear drive and full circular braking disc and flywheel braking systems are used in a vehicle, during a right hand turn the, the right side electric gear drive motors are depowered, and the left side electric gear drive motors receive additional power to assist the vehicle's right hand turns.

The Cross-Over Electro-Magnetic Engine 10 shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a Cross-Over Electro-Magnetic Engine 10 in accordance with the spirit of the invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A cross-over electro-magnetic engine system, comprising:
a) one or more magnetic pistons and a magnetic cylinder head;
b) an electromagnetic ignition module capable of charging said magnetic head in north-south reverse polarity;
c) a flywheel having magnetically tipped lobes attached to said magnetic pistons by a piston rod, rotatable connected to a crank shaft; and
d) a crankcase housing said flywheels and said crankshaft wherein said crankcase housing has one or more magnetic field arrays positioned to coincide with each flywheel;
whereby when electronically charged said magnetic head assist said magnetic pistons to move up and down causing said flywheels to rotate, and further wherein said magnetically lined flywheels are assisted by the magnetic fields located in said crankcase.

2. An electro-magnetic generator, comprising:
a) round vertical rotating or round horizontal counter-rotating plate armatures have a plurality of electromagnets on their outer circumference, and wherein said electromagnets align with stationary magnetic fields mounted within an airless cavity;
b) a plurality of electromagnets within said airless cavity, wherein said electromagnets align with stationary magnetic fields mounted within an airless cavity;
c) a central power shaft connected to said round vertical rotating or round horizontal counter-rotating disc plate armatures; and
d) a gearbox to transfer the power generated by the rotation of said round vertical rotating or round horizontal counter-rotating disc plate armatures to a drive shaft;
whereby using the attractive and repulsive forces of the magnetic fields created by the electromagnets, the disc plate armatures rotate or counter-rotate and generate electrical power.

3. An electro-magnetic ignition module, comprising a housing having a cylindrical portion, a hex portion and a threaded portion, wherein electrodes run through the cylindrical portion and extend out of the top of the cylindrical portion and the bottom of the threaded portion;
and further wherein there is a larger central electrode pin extending from the top of the cylindrical portion;
wherein said cylindrical portion is filled with insulative material.

4. An electro-magnetic braking system, comprising:
a) a mechanical brake system assembly housing including a hydraulic ram actuator assembly having, a hydraulic piston and one or more brake actuator ram shafts passing through one or more ram shaft openings on a housing endcap;
b) within the mechanical brake system assembly there is one or more stationary braking flywheel discs and one or more braking disc plates;
c) located at the distal end a driveshaft is a wheel mounting plate having wheel lug openings for accepting wheel lugs;
d) further wherein said electric motor assembly houses an electric motor drive gear and wheel drive gear and a centrally located center power and braking shaft;
whereby said hydraulic piston forces said brake actuator ram shafts passing through said ram shaft openings to press against said stationary braking flywheel discs and those in turn push up against said braking disc plates thereby slowing the rotation of said center power and braking shaft and thus slowing the vehicle.
